(19) United States
(12) Patent Application Publication
(10) Pub. No.: US 2026/0368203 A1
(43) Pub. Date: Nov. 19, 2026

(54) GENERATING SYNTHETIC RELATIONAL DATABASES VIA GRAPH-CONDITIONAL DIFFUSION MODELS

(71) Applicant: SAP SE, Walldorf (DE)

(72) Inventors: Mohamed Amine Ketata, Munich (DE); Stephan Günnemann, Munich (DE)

(21) Appl. No.: 19/677,407

(22) Filed: May 14, 2026

Related U.S. Application Data
(60) Provisional application No. 63/806,367, filed on May 15, 2025.

(51) Int. Cl. G06F 16/28; G06F 16/901

(52) U.S. Cl. CPC G06F 16/284; G06F 16/9024

(57) ABSTRACT

The present disclosure relates to computer-implemented methods, software, and systems for data processing. One example method includes obtaining a graph that comprises nodes and edges connecting at least a subset of the nodes; generating an initial feature representation corresponding to the graph, wherein the initial feature representation comprises an initial feature vector for each node in the graph; executing, by using a diffusion model, a reverse diffusion process that comprises a plurality of denoising steps to update the initial feature representation to generate a final feature representation corresponding to the graph, wherein the final feature representation comprises a final feature vector for each node in the graph; and generating the relational database based on the final feature representation.

### CROSS-REFERENCE TO RELATED APPLICATION

This application claims priority to U.S. Provisional Application No. 63/806,367, filed on May 15, 2025. The disclosure of the prior application is considered part of and is incorporated by reference in the disclosure of this application.

### TECHNICAL FIELD

The present disclosure relates to computer-implemented methods, software, and systems for data processing.

### SUMMARY

Implementations of the present disclosure are generally directed to computer-implemented method for generating synthetic relational databases by using graph-conditional diffusion models.

In a first aspect, one example method may include operations such as obtaining a graph that comprises nodes and edges connecting at least a subset of the nodes, wherein each node represents a row in a relational database, and an edge of the edges that connects a first node and a second node represents a reference from a first row in the relational database represented by the first node to a second row in the relational database represented by the second node; generating an initial feature representation corresponding to the graph, wherein the initial feature representation comprises an initial feature vector for each node in the graph; executing, by using a diffusion model, a reverse diffusion process that comprises a plurality of denoising steps to update the initial feature representation to generate a final feature representation corresponding to the graph, wherein the final feature representation comprises a final feature vector for each node in the graph; and generating the relational database based on the final feature representation

In some instances, the relational database comprises a plurality of tables.

In some instances, the first row represented by the first node and the second row represented by the second node belong to different tables among the plurality of tables.

In some instances, the edge is a directed edge that points from the first node to the second node.

In some instances, the initial feature vector for a node of the nodes represents a plurality of features of a row represented by the node, the plurality of features comprising a discrete feature and a continuous feature.

In some instances, generating the initial feature representation corresponding to the graph comprises, for each node in the graph: applying an encoding scheme to the discrete feature to generate a continuous space of possible values for the discrete feature; and generating the initial feature vector for the node based on sampling a value from a noise distribution across the continuous space of possible values.

In some instances, obtaining the graph comprises: generating one or more root nodes; and for each root node: generating one or more child nodes of the root node in accordance with a predetermined node degree distribution.

In some instances, executing the reverse diffusion process comprises, at each denoising step in the plurality of denoising steps: obtaining an intermediate feature representation corresponding to the graph for the denoising step; generating, by the diffusion model based on the intermediate feature representation, a denoising output for the denoising step; and updating, based on the denoising output, the intermediate feature representation to generate an updated feature representation corresponding to the graph for the denoising step.

In some instances, when the denoising step is a first denoising step, the intermediate feature representation is the initial feature representation.

In some instances, when the denoising step is a last denoising step, the updated feature representation is the final feature representation.

In some instances, the diffusion model has a graph neural network architecture.

In some instances, the method further comprises providing the relational database for presentation in a user interface of a client device.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 presents a graph and tabular representation of an example relational database.

FIG. 3 is a flow diagram for an example method for generating a relational database in accordance with implementations of the present disclosure.

FIG. 4 presents a comparison of autoregressive and joint relational database generation.

FIG. 5 is a schematic diagram of an example computing system.

### DETAILED DESCRIPTION

Synthetic data generation addresses critical challenges in real-world datasets, including privacy risks, data scarcity, and fairness concerns. Some existing relational data generation approaches for generating synthetic tabular data focus on single-table databases. When addressing multi-table databases, these approaches perform the generation autoregressively, generating a table before starting to generate the next one. Autoregressive generation enforces a fixed table order and models each table conditionally, which limits parallelism, constrains downstream applications that operate on the databases (e.g., missing value imputation), and compounds errors due to conditional independence assumptions. Moreover, autoregressive generation may lead to error accumulation, limit the use in downstream tasks like missing value imputation, or leads to a generation runtime that scales linearly with the number of tables and is not parallelizable, among others.

The diffusion-based approach described in the present disclosure provides technical advantages over these existing relational data generation approaches by generating all database rows simultaneously in parallel, avoiding the strict, predefined table ordering and limiting conditional independence assumptions that bottleneck traditional autoregressive approaches. The diffusion-based approach achieves significant computational efficiency gains by splitting the process: it first generates the featureless graph data structure to avoid a combinatorial explosion of edge calculations, and then generates the node features using a bounded, localized K-hop neighborhood that keeps memory usage low and scales easily to massive databases. This parallelized, localized approach enables a relational database generation system to be more than two and a half (2.5) times faster than its sequential, autoregressive counterpart when generating relational databases having comparable sizes. Moreover, the diffusion-based approach improves the fidelity of the synthetic relational databases because the reverse diffusion process, which generates all rows across all tables simultaneously in parallel, prevents the compounding errors found in autoregressive generation.

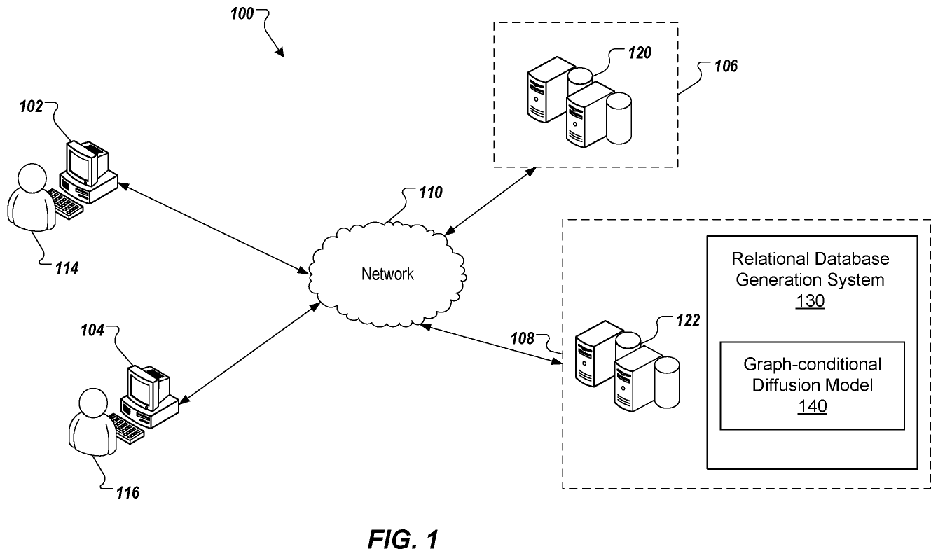

FIG. 1 depicts an example architecture 100 in accordance with implementations of the present disclosure. In the depicted example, the example architecture 100 includes a client device 102, a client device 104, a network 110, and a computing environment 106 (or simply, an environment 106) and a computing environment 108 (or simply, an environment 108). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

Each environment 106, 108 includes infrastructure components 120, 122, e.g., servers, storage devices, network nodes (e.g., hardware), deployment software, platform virtualization (e.g., a hypervisor layer), or the like. In the example of FIG. 1, the environment 108 is intended to represent various forms of servers including, but not limited to, a web server, a database server, an application server, a proxy server, a network server, and/or a server pool. In general, server systems accept requests for services and provides such services to any number of client devices (e.g., the client device 102 over the network 110).

The environment 108 can host applications and databases running on the infrastructure components 122. In some instances, the environment 108 can be a cloud environment or an on-premise environment In some instances, the environment 108 can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

In accordance with implementations of the present disclosure, the environment 108 includes a relational database generation system 130 that can generate relational databases by using a graph-conditional diffusion model 140. For example, the relational database generation system 130 can receive, from a client device, a request for synthetic database generation and, in response, use the graph-conditional diffusion model 140 to generate a relational database.

As used herein, a “relational database” refers to a plurality of interconnected tables combined with a database schema. Each individual table in the set of interconnected tables represents one specific entity type and is composed of multiple rows. The database schema defines the exact connections between the plurality of tables. For example, the database schema can establish parent-child relationships where rows in a child table contain references to rows in a parent table.

Being called a “graph-conditional” diffusion model 140 signifies that the diffusion model 140 is conditioned on data derived from a graph when executing a generation process (a reverse diffusion process) to generate a relational database. A reverse diffusion process is an iterative generative technique in the field of generative artificial intelligence that generates (e.g., reconstructs) data from pure noise. The graph represents a structure of the relational database. The reverse diffusion process includes a plurality of denoising steps. In other words, the relational database is generated after the denoising step of the plurality of denoising steps.

In some implementations, the reverse diffusion process is a Gaussian reverse diffusion process. As a particular example, the reverse diffusion process can be one of the Gaussian reverse diffusion processes described in Jonathan Ho, Ajay Jain, and Pieter Abbeel. Denoising diffusion probabilistic models. Advances in neural information processing systems, 33:6840-6851, 2020 and Akim Kotelnikov, Dmitry Baranchuk, Ivan Rubachev, and Artem Babenko. Tabddpm: Modelling tabular data with diffusion models. In International Conference on Machine Learning, pages 17564-17579. PMLR, 2023.

As used herein, a “graph” refers to a data structure that includes nodes and edges connecting at least a subset of the nodes.

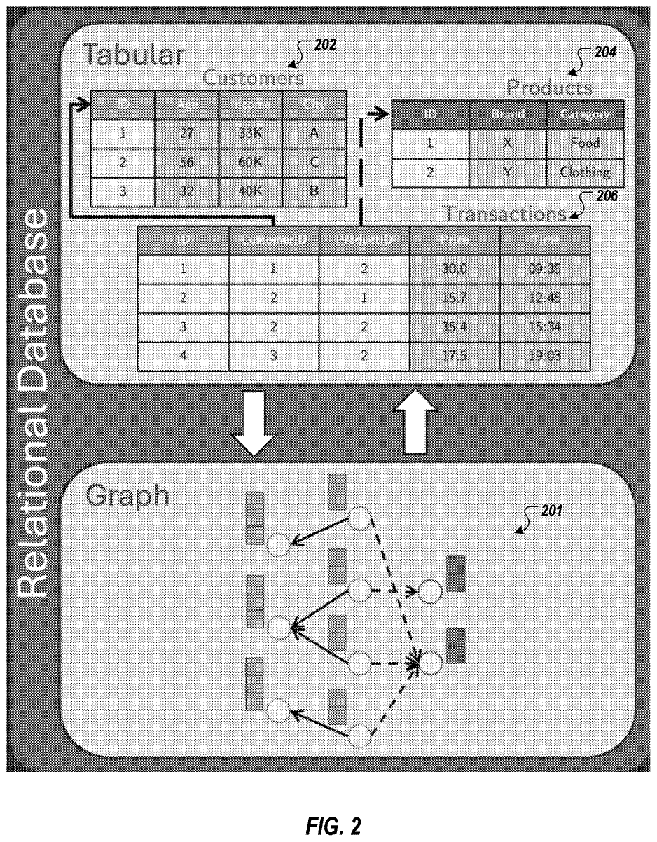

FIG. 2 presents a graph and tabular representation of an example relational database. In some implementations, as illustrated in FIG. 2, the graph 201 is a directed heterogeneous graph G=(V,E,X), with V representing a set of nodes, E representing a set of edges, and X representing a set of features.

The set of nodes, denoted as V, can represent individual rows across the entire database. Because a database contains a plurality of distinct tables (e.g., a Customers table, a Products table, and a Transactions table in the example of FIG. 2), the graph is a heterogeneous, meaning each node is assigned a specific type based on the table among the plurality of distinct tables that includes the corresponding row represented by the node. For example, in FIG. 2, there are three types of nodes: nodes of a first type that represent the rows from the Customers table, nodes of a second type that represents the rows from the Products table, and nodes of a third type that represents the rows from the Transactions table.

The set of edges, denoted as E, can represent the primary-foreign key relationships linking those rows; thus, an edge can only exist between nodes of different types. If a row in a child table contains a foreign key referencing a row in a parent table, a directed edge connects their two corresponding nodes. This directed edge points from a child node (representing the row in the child table) to a parent node (representing the row in the parent table) it references. Consequently, all primary and foreign keys are entirely encoded by the edges of the graph, rather than existing as numerical or categorical features on the nodes themselves.

Because the graph includes various node types (representing the plurality of distinct tables), the edges connecting them are also categorized into distinct edge types. An edge type is defined by the types of the two nodes it connects. Specifically, if an edge connects a child node 11 to a parent node 12, the edge can be assigned a type of (i, j), where i and j are the specific types of those two nodes (tables).

The set of features, denoted as X, represents all the non-key attributes (or columns) of the rows across the entire database. While the graph's nodes (V) and edges (E) encode the structural skeleton of the database—meaning all primary and foreign keys are represented by the graph's structure—the feature set X contains the actual descriptive data that populates those nodes.

For a specific node v, its feature vector xᵥ can include the features describing the entity represented by that node. For example, in FIG. 2, the features of each row in the Customers table 202 include a customer's age, income, and city, the features of each row in the Products table 204 include a product's brand and category, and the features of each row in the Transactions table 206 include price and time. Customer ID and Product ID are foreign keys.

These features can include discrete data (e.g., categorical data), continuous data (e.g., numerical data), or both, and possibly other types of data (e.g., ordinal data), date data, time data, and so on. Discrete data refers to data that may take on or have a finite or countably infinite number of values; continuous data may take on any value within a continuous space of possible values.

In some instances, the graph-conditional diffusion model 140 can have any appropriate graph neural network architecture, i.e., can include any number of graph neural network layers, e.g., graph convolutional network (GCN) layers, graph attention network (GAT) layers, message passing neural network (MPNN) layers, and so on. Optionally, the graph-conditional diffusion model 140 can include any number of other types of neural network layers, e.g., fully connected layers, convolutional layers, embedding layers, and so on.

As a particular example, the graph-conditional diffusion model 140 can have one of the message passing graph neural network architectures described in Justin Gilmer, Samuel S Schoenholz, Patrick F Riley, Oriol Vinyals, and George E Dahl. Neural message passing for quantum chemistry. In International conference on machine learning, pages 1263-1272. PMLR, 2017, and Michael Schlichtkrull, Thomas N Kipf, Peter Bloem, Rianne Van Den Berg, Ivan Titov, and Max Welling. Modeling relational data with graph convolutional networks. In The semantic web: 15th international conference, ESWC 2018, Heraklion, Crete, Greece, Jun. 3-7, 2018, proceedings 15, pages 593-607. Springer, 2018.

Once the relational database is generated by the relational database generation system 130 by using the graph-conditional diffusion model 140, the relational database generation system 130 can provide the relational database to the user. For example, the relational database generation system 130 can provide the relational database for presentation in a user interface of a client device, e.g., the client device through which the user submitted the request for synthetic database generation.

Additionally or alternatively, the relational database generation system 130 can provide the relational database to another system in the same or different environment, e.g., the environment 106, for further processing, or store the relational database in a storage device for some future purpose. In other words, the synthetic relational database can logically be interacted with just like any real-world relational database.

For example, the relational database can be loaded directly into any standard Relational Database Management System (RDBMS), which can operate on the relational database in response to received commands. Examples of database operations include querying, which involves retrieving specific information from the relational database, often by combining data from multiple connected tables; searching, which involves identifying specific values, strings, or patterns within the database columns; filtering, which narrows down the relational database to only return rows that meet strict conditions (e.g., mathematical or categorical conditions); and defining instructions (data definition and manipulation), which involve issuing commands that manage the structure, rules, and contents of the relational database itself.

As another example, the relational database generation system 130 or another system can use the relational database for product development and testing. Real-world relational databases may store sensitive personal and organizational data in domains like cybersecurity, healthcare, and product development (e.g., database performance optimization and software debugging). Strict privacy regulations often prevent developers from using real data to test software or optimize database queries. On the other hand, the synthetic, relational databases generated by the relational database generation system 130 preserve statistical properties and multi-hop correlations of real-world relational datasets, while obfuscating sensitive information. The environment 108 could then use these synthetic, relational databases to rigorously test enterprise software applications against realistic data distributions prior to deploying them.

As another example, the relational database generation system 130 or another system can use the relational database for data augmentation purposes. A training system can use the synthetic, relational databases to augment or expand limited or imbalanced real-world datasets, such as generating relational databases that represent synthetic examples of rare anomalies or supply chain disruptions.

By augmenting or expanding these real-world datasets while preserving complex, multi-hop inter-table dependencies, the training system could train more robust predictive machine learning models to improves its accuracy in identifying unusual patterns, outliers, or deviations from normal behavior within relational databases, compared with baseline predictive machine learning models that are trained exclusively on real-world relational datasets.

Additionally or alternatively, the training system could train a machine learning model to improve its performance on any of a variety of automated data processing, schema mapping, or other analytical tasks on relational databases. As a particular example, the training system could train a machine learning model that is configured as a predictive foundational model for missing value imputation, i.e., for predicting any subset of missing data values inside a database based on processing the remaining subset of available data values in the database, while preserving the statistical patterns observed in real data included in the database.

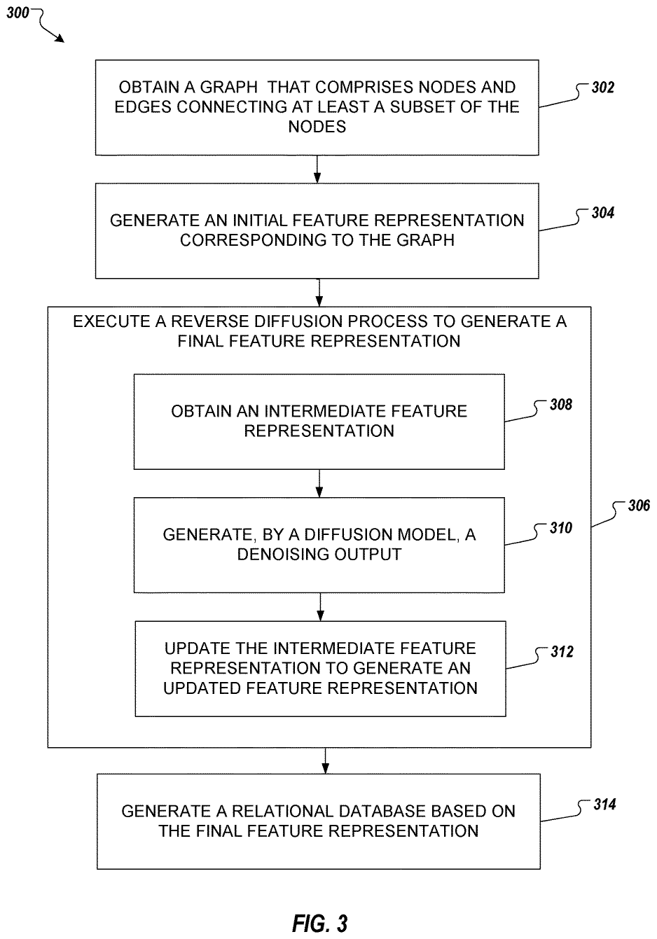

FIG. 3 is a flow diagram for an example method 300 for generating a relational database that includes a plurality of tables in accordance with implementations of the present disclosure. Steps or operations of the example method 300 can be executed by a relational database generation system, e.g., the relational database generation system 130 of FIG. 1.

At 302, a graph is obtained. The graph includes nodes and edges connecting at least a subset of the nodes. Each node represents a row in the relational database. Each node is assigned a specific type based on the table among the plurality of tables that includes the corresponding row represented by the node. An edge can only exist between nodes of different types. Each edge is assigned a type that is defined by the types of the two nodes it connects. An edge that connects a first node of a first type and a second node of a second type represents a reference from a first row represented by the first node to a second row represented by the second node, where the first row and the second row belong to distinct tables.

In some implementations, the relational database generation system obtains the graph by retrieving the graph from a storage device or a graph generation service. In some implementations, the relational database generation system obtains the graph by generating the graph using a node degree-preserving random graph generation technique, which begins with generating one or more root nodes.

Root nodes are nodes with no outgoing edges (representing rows that do not contain any foreign keys). The exact number of root nodes being generated can be predetermined, e.g., based on the numbers of root nodes in a set of one or more training relational databases on which the graph-conditional diffusion model has been trained, a desired size of the relational database to be generated, and so on.

The node degree-preserving random graph generation technique then involves recursive sampling. For each root node, the relational database generation system generates one or more child nodes of the root node according to a predetermined node degree distribution; it then recursively repeats this sampling process for all the newly created child nodes, building out the graph connection by connection.

In some implementations, the predetermined node degree distribution is an indegree distribution in the set of training relational databases on which the graph-conditional diffusion model has been trained. An indegree represents the number of incoming edges a node receives for a specific edge type (i.e., how many child rows point to a specific parent row). By repeatedly generating child nodes according to the indegree distribution, the relational database generation system can generate a graph representing a structure of a relational database that statistically mirrors those on which the graph-conditional diffusion model has been trained by preserving its node degree distribution, i.e., the frequency of incoming (indegree) connections between different tables.

At 304, an initial feature representation corresponding to the graph is generated. The initial feature representation includes an initial feature vector for each node in the graph. The initial feature representation has the same dimensionality as a final feature representation that can be generated by executing a reverse diffusion process on the initial feature representation, but has noisy values.

Generally, the relational database generation system can generate the initial feature representation based on sampling from a noise distribution, e.g., a Gaussian distribution, or a different noise distribution. That is, the final feature representation includes a plurality of feature vectors (that correspond respectively to the nodes in the graph), and the initial feature representation includes the same number of feature vectors, with the values in the feature vectors being sampled from noise distributions.

For each node, the corresponding feature vector can represent one or more discrete features, one or more continuous features, or both. For a continuous feature, generating the initial feature vector can involve sampling a value from a corresponding noise distribution, e.g., a Gaussian distribution, or a different noise distribution, across the continuous space of possible values for the continuous feature.

For a discrete feature, because its value can only have a finite or countably infinite number of values, generating the initial feature vector can involve applying an encoding scheme to the discrete feature to generate a continuous space of possible values for the discrete feature, and sampling a value from a corresponding noise distribution across the continuous space of possible values. The encoding scheme is a data transformation technique that allows the relational database generation system to map discrete data into a continuous space. For example, given a discrete feature with n distinct values {c₁, . . . , cₙ}, the relational database generation system can apply an encoding scheme E:{c₁, . . . , cₙ}→{0, . . . , n−1} that maps each distinct value cᵢ to a unique integer value.

At 306, a reverse diffusion process is executed by using the graph-conditional diffusion model to update the initial feature representation to generate the final feature representation corresponding to the graph. The final feature representation includes a final feature vector for each node in the graph. The reverse diffusion process includes a plurality of denoising steps. An iteration of operations 308-312 can be performed at each denoising step.

An intermediate feature representation corresponding to the graph is obtained for the denoising step (308). The intermediate feature representation includes a plurality of noisy feature vectors. For the first iteration of operations 308-312, the intermediate feature representation is the initial feature representation generated at step 304. For any subsequent iteration of operations 308-312, the intermediate feature representation is the updated feature representation generated in a preceding iteration of operations 308-312.

The graph-conditional diffusion model processes a diffusion model input to generate a denoising output for the denoising step (310). The diffusion model input includes, for each node in the graph, a local K-hop neighborhood subgraph,

$${G}_{v , K}^{( t )} ,$$

that is generated from the intermediate feature representation. The diffusion model input also includes data defining a timestep, t, which identifies a current noise level of the intermediate feature representation. The denoising output defines an estimate of the noise that needs to be removed from the intermediate feature representation to arrive at the final feature representation. For example, the denoising output can include a noise vector for each noisy feature vector.

Instead of trying to process the entire massive database graph at once to denoise a single node—which would be computationally unscalable and largely unnecessary, since most distant rows are irrelevant to the target row—the relational database generation system isolates a small, relevant neighborhood around each node. When generating the local K-hop neighborhood subgraph for each node, the relational database generation system treats the graph as undirected by adding reverse edges to all existing connections. This allows a node to gather relational context from both directions: it can interact with its parent nodes (the rows it references) as well as its child nodes (the rows that reference it).

At any given denoising step t, the local K-hop neighborhood subgraph for a given node v includes:
The nodes: all other nodes (rows) that are within K connections (hops) of the given node, where K is a tunable hyperparameter of the relational database generation system. For example, if K=1, the subgraph contains the row represented by the given node, all its parent rows, and all its child rows.
The edges: the structural links connecting this localized group of nodes.
The noisy feature vectors: The current, partially noisy feature vectors of all the nodes that are within K connections (hops) of the given node.

The intermediate feature representation is updated based on the denoising output to generate an updated feature representation corresponding to the graph for the denoising step (312). The updated feature representation includes a plurality of partially denoised feature vectors. For example, updating the intermediate feature representation can involve removing a noise from each noisy feature vector included in the intermediate feature representation in accordance with the noise vector for the noisy feature vector included in the denoising output.

At 314, the relational database is generated based on the graph and the final feature representation corresponding to the graph. The final feature representation is the updated feature representation generated in the last denoising step in the plurality of denoising steps in the reverse diffusion process. The final feature representation includes a plurality of fully denoised feature vectors.

For each node, the corresponding fully denoised feature vector can represent one or more discrete features, one or more continuous features, or both. For a continuous feature, a value in the corresponding fully denoised feature vector can be used exactly it is. For a discrete feature, because the encoding scheme that is previously used to transform it to the continuous space of possible values is invertible, a value in the corresponding fully denoised feature vector is first mapped back by applying an inverse encoding scheme to a mapped value in a discrete space.

Generating the relational database based on the final feature representation involves converting the graph back into a tabular format. This is accomplished by assigning a unique primary key to each node, using the generated edges to populate the foreign keys, and stacking these keys alongside the continuous features, which have the corresponding values included as is in the final feature representation, and the discrete features, which have the mapped values generated by applying the inverse encoding scheme to the corresponding values included in the final feature representation, to form the rows of each table.

Thus, during the reverse diffusion process, the graph-conditional diffusion model processes all nodes in the graph jointly, and the feature vectors for all nodes in the graph are updated based on the denoising output simultaneously at each denoising step. This allows all of the plurality of tables of the relational database to be generated jointly and in parallel with each other. Jointly generating tables of a relational database offers a number of technical advantages in comparison to autoregressive approaches where tables of a relational database are generated one after another, in a sequential order.

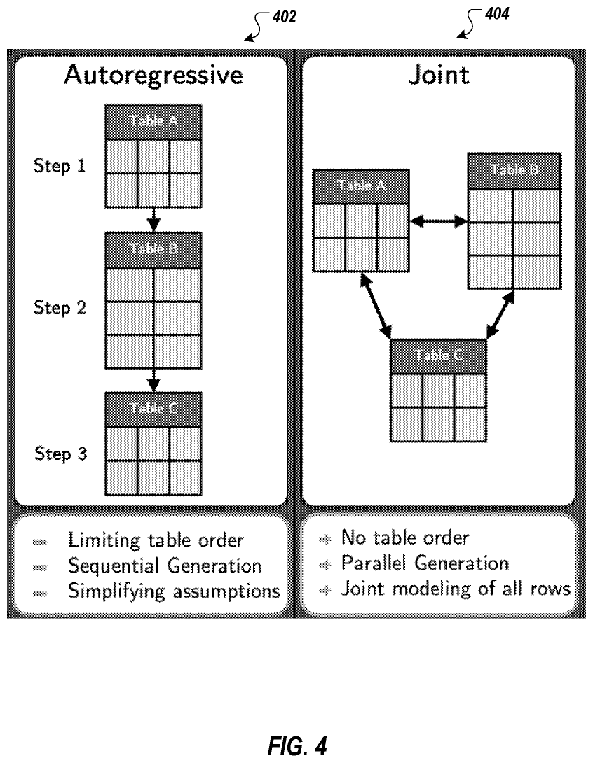

FIG. 4 presents a comparison of autoregressive in accordance with implementations of existing relational data generation approaches and joint relational database generation in accordance with implementations of the present disclosure. The left side (“Autoregressive 402”) depicts autoregressive relational database generation, which generates tables sequentially in distinct steps (e.g., Step 1 generates Table A, Step 2 generates Table B, etc.). This approach requires a strict, predefined table ordering, limits the ability to generate data in parallel, and often relies on simplifying conditional independence assumptions that can fail to capture complex dependencies between tables.

The right side (“Joint 404”) depicts graph-conditional, diffusion-based relational database generation. For example, the graph-conditional, diffusion-based relational database generation can be performed by the relational database generation system 130 of FIG. 1. Instead of processing tables one by one, the diffusion-based approach generates all rows across all tables (Table A, Table B, and Table C) simultaneously in parallel. By avoiding a fixed table order, this diffusion-based approach allows the relational database generation system to jointly learn and preserve the complex, long-range correlations that exist across the entire relational database.

Prior to being used to generate the relational database, the graph-conditional diffusion model can have been trained by the relational database generation system 130 of FIG. 1, or another training system, on the set of training relational databases across a plurality of training iterations. Each training iteration is performed based on a training relational database selected from the set of training relational databases and includes the following steps:
1 Sample a target node: A target node v is randomly selected from a graph representing the training relational database.
2 Extract the neighborhood: the target node's local K-hop neighborhood subgraph is generated by temporarily treating the graph representing the training relational database as an undirected graph to gather both parent and child connections.
3 Sample a timestep: a timestep t is selected from the full sequence of timesteps included in a reverse diffusion process (ranging from 1 to T).
4 Add noise: A level of Gaussian noise corresponding to the timestep t is added to the original features of the target node v and all the other nodes in its local K-hop neighborhood to generate a partially noisy, localized subgraph.
5 Predict the noise: The partially noisy, localized subgraph and data defining the timestep t is processed by the graph-conditional diffusion model to generate a training denoising output that defines an estimate of the noise that was added to original feature of the target node v.
6 Update the model: A loss function, which evaluates a difference (e.g., a squared difference) between the estimate of the noise generated by the graph-conditional diffusion model and the actual noise that was added in step 4, is computed. A gradient descent step is then taken to update parameters of the graph-conditional diffusion model based on gradients of the loss function computed with respect to the parameters.

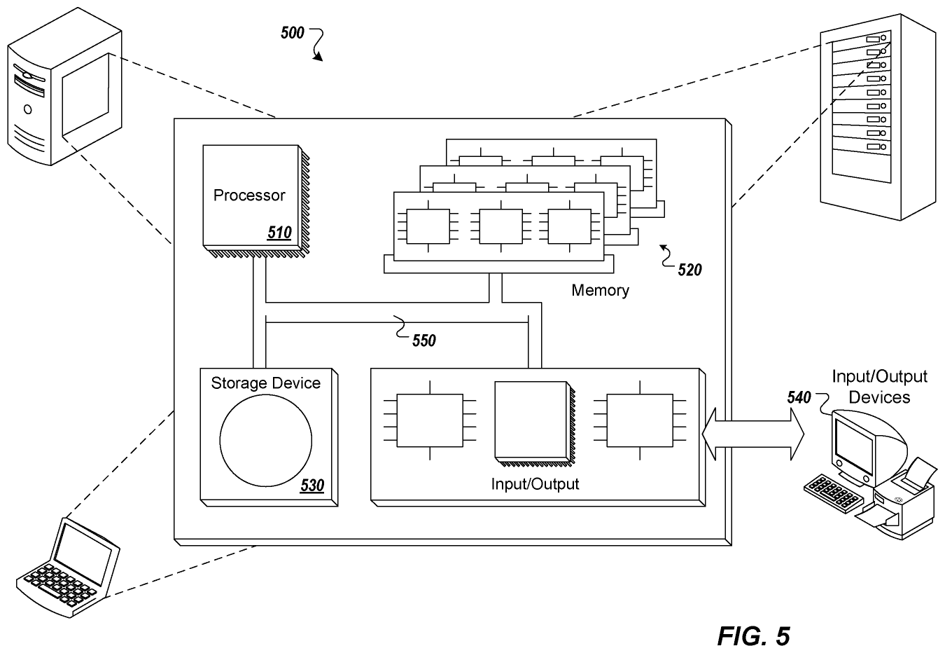

FIG. 5 is a schematic diagram of an example computing system 500. The system 500 can be used for the operations described in association with the implementations described herein. For example, the system 500 may be included in the relational database generation system 130 or the training system. The system 500 includes a processor 510, a memory 520, a storage device 530, and an input/output device 540. The components 510, 520, 530, 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

One or more of the processors may be graphics processing units (GPUs). In an embodiment, a GPU may be a processor that is a specialized electronic circuit designed to process mathematically intensive applications. The GPU may have a parallel structure that is efficient for parallel processing of large blocks of data, such as mathematically intensive data common to machine learning workloads, e.g., neural network training or inference workloads, computer graphics applications, images, videos, etc.

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

### Examples

Although the present application is defined in the attached claims, it should be understood that the present invention can also (additionally or alternatively) be defined in accordance with the following examples:

Example 1. A computer-implemented method comprising:
obtaining a graph that comprises nodes and edges connecting at least a subset of the nodes, wherein each node represents a row in a relational database, and an edge of the edges that connects a first node and a second node represents a reference from a first row in the relational database represented by the first node to a second row in the relational database represented by the second node;
generating an initial feature representation corresponding to the graph, wherein the initial feature representation comprises an initial feature vector for each node in the graph;
executing, by using a diffusion model, a reverse diffusion process that comprises a plurality of denoising steps to update the initial feature representation to generate a final feature representation corresponding to the graph, wherein the final feature representation comprises a final feature vector for each node in the graph; and
generating the relational database based on the final feature representation.

Example 2. The method of Example 1, wherein the relational database comprises a plurality of tables.

Example 3. The method of Example 2, wherein the first row represented by the first node and the second row represented by the second node belong to different tables among the plurality of tables.

Example 4. The method of any one of Examples 1-3, wherein the edge is a directed edge that points from the first node to the second node.

Example 5. The method of any one of Examples 1-4, wherein initial feature vector for a node of the nodes represents a plurality of features of a row represented by the node, the plurality of features comprising a discrete feature and a continuous feature.

Example 6. The method of Example 5, wherein generating the initial feature representation corresponding to the graph comprises, for each node in the graph: applying an encoding scheme to the discrete feature to generate a continuous space of possible values for the discrete feature; and generating the initial feature vector for the node based on sampling a value from a noise distribution across the continuous space of possible values.

Example 7. The method of any one of Examples 1-6, wherein obtaining the graph comprises:
generating one or more root nodes; and
for each root node: generating one or more child nodes of the root node in accordance with a predetermined node degree distribution.

Example 8. The method of any one of Examples 1-7, wherein executing the reverse diffusion process comprises, at each denoising step in the plurality of denoising steps:
obtaining an intermediate feature representation corresponding to the graph for the denoising step;
generating, by the diffusion model based on the intermediate feature representation, a denoising output for the denoising step; and
updating, based on the denoising output, the intermediate feature representation to generate an updated feature representation corresponding to the graph for the denoising step.

Example 9. The method of Example 8, wherein when the denoising step is a first denoising step, the intermediate feature representation is the initial feature representation.

Example 10. The method of Example 8, wherein when the denoising step is a last denoising step, the updated feature representation is the final feature representation.

Example 11. The method of any one of Examples 1-10, wherein the diffusion model has a graph neural network architecture.

Example 12. The method of any one of Examples 1-11, further comprising providing the relational database for presentation in a user interface of a client device.

Example 13. A non-transitory, computer-readable medium storing one or more instructions executable by a computer system to perform one or more operations according to the method of any one of Examples 1 to 12.

Example 14. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations according to the method of any one of Examples 1 to 12.

1. A computer-implemented method comprising:
obtaining a graph that comprises nodes and edges connecting at least a subset of the nodes, wherein each node represents a row in a relational database, and an edge of the edges that connects a first node and a second node represents a reference from a first row in the relational database represented by the first node to a second row in the relational database represented by the second node;
generating an initial feature representation corresponding to the graph, wherein the initial feature representation comprises an initial feature vector for each node in the graph;
executing, by using a diffusion model, a reverse diffusion process that comprises a plurality of denoising steps to update the initial feature representation to generate a final feature representation corresponding to the graph, wherein the final feature representation comprises a final feature vector for each node in the graph; and
generating the relational database based on the final feature representation.

2. The method of claim 1, wherein the relational database comprises a plurality of tables.

3. The method of claim 2, wherein the first row represented by the first node and the second row represented by the second node belong to different tables among the plurality of tables.

4. The method of claim 1, wherein the edge is a directed edge that points from the first node to the second node.

5. The method of claim 1, wherein the initial feature vector for a node of the nodes represents a plurality of features of a row represented by the node, the plurality of features comprising a discrete feature and a continuous feature.

6. The method of claim 5, wherein generating the initial feature representation corresponding to the graph comprises, for each node in the graph:
applying an encoding scheme to the discrete feature to generate a continuous space of possible values for the discrete feature; and
generating the initial feature vector for the node based on sampling a value from a noise distribution across the continuous space of possible values.

7. The method of claim 1, wherein obtaining the graph comprises:
generating one or more root nodes; and
for each root node: generating one or more child nodes of the root node in accordance with a predetermined node degree distribution.

8. The method of claim 1, wherein executing the reverse diffusion process comprises, at each denoising step in the plurality of denoising steps:
obtaining an intermediate feature representation corresponding to the graph for the denoising step;
generating, by the diffusion model based on the intermediate feature representation, a denoising output for the denoising step; and
updating, based on the denoising output, the intermediate feature representation to generate an updated feature representation corresponding to the graph for the denoising step.

9. The method of claim 8, wherein when the denoising step is a first denoising step, the intermediate feature representation is the initial feature representation.

10. The method of claim 8, wherein when the denoising step is a last denoising step, the updated feature representation is the final feature representation.

11. The method of claim 1, wherein the diffusion model has a graph neural network architecture.

12. The method of claim 1, further comprising providing the relational database for presentation in a user interface of a client device.

13. A system comprising
a computing device; and
a computer-readable storage device coupled to the computing device and having instructions stored thereon which, when executed by the computing device, cause the computing device to perform operations comprising:
obtaining a graph that comprises nodes and edges connecting at least a subset of the nodes, wherein each node represents a row in a relational database, and an edge of the edges that connects a first node and a second node represents a reference from a first row in the relational database represented by the first node to a second row in the relational database represented by the second node;
generating an initial feature representation corresponding to the graph, wherein the initial feature representation comprises an initial feature vector for each node in the graph;
executing, by using a diffusion model, a reverse diffusion process that comprises a plurality of denoising steps to update the initial feature representation to generate a final feature representation corresponding to the graph, wherein the final feature representation comprises a final feature vector for each node in the graph; and
generating the relational database based on the final feature representation.

14. The system of claim 13, wherein the relational database comprises a plurality of tables.

15. The system of claim 14, wherein the first row represented by the first node and the second row represented by the second node belong to different tables among the plurality of tables.

16. The system of claim 13, wherein the edge is a directed edge that points from the first node to the second node.

17. The system of claim 13, wherein the initial feature vector for a node of the nodes represents a plurality of features of a row represented by the node, the plurality of features comprising a discrete feature and a continuous feature.

18. The system of claim 17, wherein generating the initial feature representation corresponding to the graph comprises, for each node in the graph:
applying an encoding scheme to the discrete feature to generate a continuous space of possible values for the discrete feature; and
generating the initial feature vector for the node based on sampling a value from a noise distribution across the continuous space of possible values.

19. The system of claim 13, wherein obtaining the graph comprises:
generating one or more root nodes; and
for each root node: generating one or more child nodes of the root node in accordance with a predetermined node degree distribution.

20. A non-transitory, computer-readable medium coupled to one or more processors and having instructions stored thereon which, when executed by the one or more processors, cause the one or more processors to perform operations comprising:
obtaining a graph that comprises nodes and edges connecting at least a subset of the nodes, wherein each node represents a row in a relational database, and an edge of the edges that connects a first node and a second node represents a reference from a first row in the relational database represented by the first node to a second row in the relational database represented by the second node;
generating an initial feature representation corresponding to the graph, wherein the initial feature representation comprises an initial feature vector for each node in the graph;
executing, by using a diffusion model, a reverse diffusion process that comprises a plurality of denoising steps to update the initial feature representation to generate a final feature representation corresponding to the graph, wherein the final feature representation comprises a final feature vector for each node in the graph; and
generating the relational database based on the final feature representation.
